(19) United States
(12) Patent Application Publication
(10) Pub. No.: US 2013/0115371 A1
(43) Pub. Date: May 9, 2013

(54) SYSTEM AND METHODS OF REDUCING DIFFUSE REFLECTION OF AN OPTICAL STACK

(71) Applicant: CAMBRIOS TECHNOLOGIES CORPORATION, Sunnyvale, CA (US)

(72) Inventors: Viktor Podolskiy, Westford, MA (US); Michael A. Spaid, Mountain View, CA (US); Jeffrey Wolk, Half Moon Bay, CA (US); Haixia Dai, San Jose, CA (US)

(73) Assignee: CAMBRIOS TECHNOLOGIES CORPORATION, Sunnyvale, CA (US)

(21) Appl. No.: 13/667,556

(22) Filed: Nov. 2, 2012

Related U.S. Application Data
(60) Provisional application No. 61/556,114, filed on Nov. 4, 2011.
(60) Provisional application No. 61/598,239, filed on Feb. 13, 2012.
(60) Provisional application No. 61/621,359, filed on Apr. 6, 2012.
(60) Provisional application No. 61/678,886, filed on Aug. 2, 2012.

(51) Int. Cl. B05D 5/06; G06F 7/38

(52) U.S. Cl. 427/162; 708/446

(57) ABSTRACT

The present disclosure relates to a method for improving optical qualities of transparent conductive films including a multilayer optical stack and conductive nanowires embedded therein.

### BACKGROUND

Transparent conductive films comprise electrically conductive material coated on high-transmittance surfaces or substrates, and are widely used in flat panel displays such as liquid crystal displays (LCD), touch panels or sensors, electroluminescent devices (e.g., light emitting diodes), thin film photovoltaic cells, or as anti-static layers and electromagnetic wave shielding layers.

Currently, vacuum deposited metal oxides, such as indium tin oxide (ITO), are the industry standard materials for providing optical transparency and electrical conductivity to dielectric surfaces such as glass and polymeric films. However, metal oxide films are fragile and prone to damage during bending or other physical stresses. They also require elevated deposition temperatures and/or high annealing temperatures to achieve high conductivity levels. For certain substrates that are prone to adsorbing moisture, such as plastic and organic substrates (e.g., polycarbonates), it becomes problematic for a metal oxide film to adhere properly. Applications of metal oxide films on flexible substrates are therefore severely limited. In addition, vacuum deposition is a costly process and requires specialized equipment.

In recent years there is a trend to replace current industry standard transparent conductive ITO films in flat panel displays with a composite material of metal nanowires (e.g., silver nanowires). Typically, a transparent conductive film is formed by first coating on a substrate an ink composition including silver nanowires and a binder. Thereafter, a transparent UV or thermally curable polymer materials can be coated to form a protective layer. Nanowire-based coating technologies are particularly suited for printed electronics. Using a solution-based format, printed electronic technology makes it possible to produce robust electronics on large-area, flexible substrates.

The presence of nanowires in transparent conductive films may give rise to certain optical challenges that are not typically encountered in ITO films, which are continuous. For example, when an ITO touch sensor is turned off, the ITO touch sensor appears black in the ambient light; whereas a touch sensor made from silver nanowire-based transparent films may have a “milkier” or “cloudier” look. The milky appearance may affect the image quality (when the LCD module is on) manifested as a lower contrast ratio, or other image issues. Thus, there is a need to address the optical challenges unique to nanowire-based transparent conductors.

### BRIEF SUMMARY

Provided herein are various embodiments directed to methods that address the milky appearance of nanowire displays by reducing or minimizing diffuse reflection in optical stacks that include at least one nanowire-based conductive film.

One embodiment is a method comprising selecting optical stack parameters for an optical stack with a nanowire and calculating a plurality of diffuse reflection values each for a respective one of a plurality of optical stack configurations according to the optical stack parameters. The method further includes selecting one of the optical stack configurations based at least on a comparison of the diffuse reflection values and forming layers of the optical stack according to the selected optical stack configuration.

In one embodiment the method includes calculating a plurality of specular reflection values each for a respective one of the optical stack configurations.

In one embodiment the calculating the diffuse reflection values comprises calculating a scattering cross-section of the nanowire. In one embodiment calculating the diffuse reflection values includes, for each optical stack configuration, respectively, calculating an electromagnetic field from incident light at a position of the nanowire within the optical stack, and calculating transfer matrices for light scattered from the nanowire within the optical stack.

In one embodiment calculating the diffuse reflection includes calculating an amount of light scattered from the nanowire based on the scattering cross-section and the field from incident light at the position of the nanowire.

In one embodiment calculating the field from incident light includes calculating an electromagnetic field from diffusely scattered light at the position of the nanowire.

In one embodiment the plurality of optical stack parameters includes a number of layers for the optical stack. In one embodiment the plurality of optical stack parameters includes a range of thicknesses of the layers of the optical stack. In one embodiment the plurality of optical stack parameters include a range of indices of refraction of the layers of the optical stack.

In one embodiment forming the layers of the optical stack includes forming a first layer on a substrate and forming a second layer on the first layer, the nanowire being positioned in the first or second layer.

In one embodiment the method includes calculating a plurality of specular reflection values each for a respective one of the plurality of optical stack configurations according to the optical stack parameters.

In one embodiment calculating the plurality of specular reflection values includes calculating transfer matrices for light incident on each of the optical stack configurations. In one embodiment selecting one of the optical stack configurations is based in part on a comparison of the specular reflection values.

In one embodiment selecting one of the optical stack configurations includes selecting the optical stack configuration corresponding to a minimum value of diffuse reflection. One embodiment is a method comprising inputting to a processor input optical stack parameters for an optical stack with a nanowire and storing the input optical stack parameters in a memory circuit coupled to the processor. The method further comprises computing, in the processor, a plurality of values of diffuse reflection for a plurality of optical stacks each having a respective configuration in accordance with the optical stack parameters. Calculating the values of diffuse reflection includes, for each configuration, respectively computing a value of electromagnetic field from incident light at a position within an optical stack corresponding to a position of a nanowire in the optical stack, and computing transfer matrices to provide a value of diffuse reflection at a surface of the optical stack based in part on the value of electromagnetic field.

In one embodiment the method includes comparing the values of diffuse reflection with each other and selecting one of the values of diffuse reflection.

In one embodiment the method includes outputting from the processor a selected optical stack configuration corresponding to the selected value of diffuse reflection.

In one embodiment the input optical stack parameters include a range of indices of refraction of at least one layer of the optical stack. In one embodiment the selected optical stack configuration includes an index of refraction from the range of indices of refraction. In one embodiment the input optical stack parameters include a range of thicknesses of a layer of the optical stack.

In one embodiment the selected optical stack configuration includes a thickness from the range of thicknesses of the layer of the optical stack.

In one embodiment the method includes forming the optical stack according to the selected optical stack configuration. In one embodiment computing the values of diffuse reflection comprises calculating a scattering cross section of the nanowire.

One embodiment is a system comprising a processor, a memory coupled to the processor, an input coupled to the processor and configured to receive first parameters of an optical stack. The processor is configured to compute a set of incident light electromagnetic field values for a position corresponding to a nanowire in an optical stack, compute a light scattering profile of the nanowire, compute a set of values of diffuse reflection at a surface of the optical stack, and estimate a set of second parameters of the optical stack. The second parameters correspond to preferred values of the set of values of diffuse reflection. An output is coupled to the processor and configured to receive the second parameters from the processor.

In one embodiment the system includes a display coupled to the output, the display being configured to display the second parameters.

In one embodiment the system includes a deposition device coupled to the output, the deposition device being configured to receive the second parameters and to deposit a first optical layer of the optical stack according to the second parameters.

One embodiment is a method comprising inputting parameters of an optical stack to a processor, estimating, in the processor, a set of values of electromagnetic field from incident light for a position corresponding to a nanowire in an optical stack, and estimating, in the processor, a light scattering profile of the nanowire. The method further comprises estimating, in the processor, a set of values of diffuse reflection at a surface of the optical stack based on electromagnetic field values and the scattering cross-section and outputting from the processor an optical stack configuration corresponding to a selected value of diffuse reflection.

In one embodiment estimating the set of values of electromagnetic field includes computing first transfer matrices according to the parameters of the optical stack.

In one embodiment estimating the set of values of the diffuse reflection includes computing second transfer matrices according to the parameters of the optical stack.

BRIEF DESCRIPTION OF THE SEVERAL VIEWS OF THE DRAWINGS In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements, and have been selected solely for ease of recognition in the drawings.

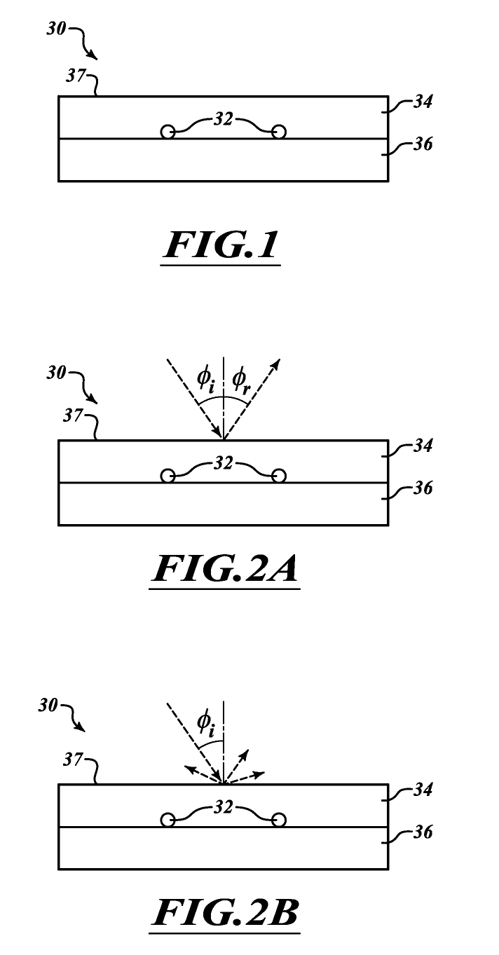

FIG. 1 is a cross section of an optical stack including nanowires according to one embodiment.

FIG. 2A illustrates specular reflection from an optical stack according to one embodiment.

FIG. 2B illustrates diffuse reflection from an optical stack according to one embodiment.

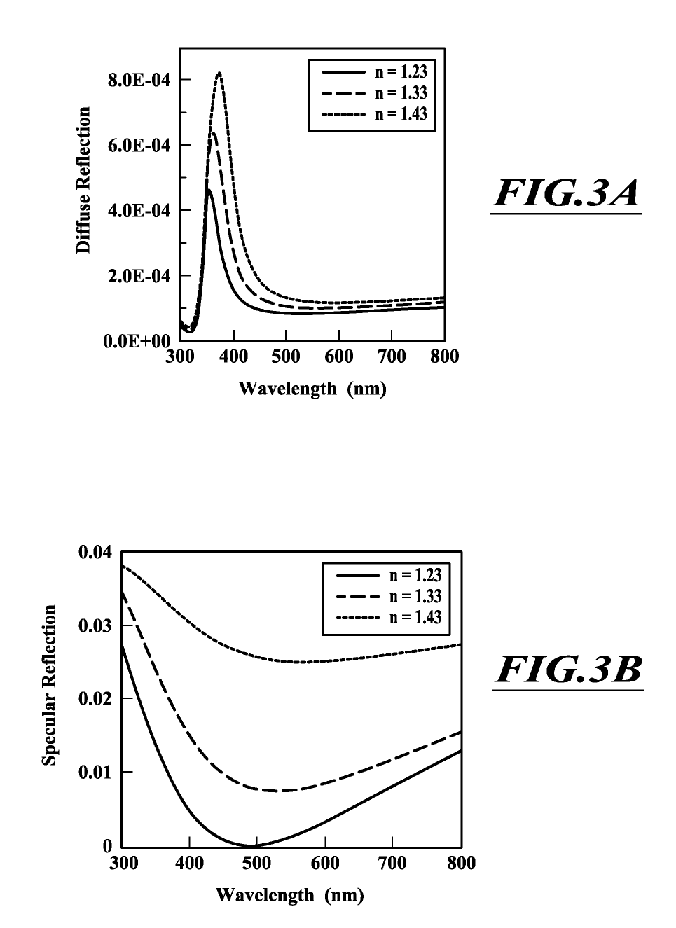

FIG. 3A is a curve of diffuse reflection in an optical stack.

FIG. 3B is a curve of specular reflection in an optical stack.

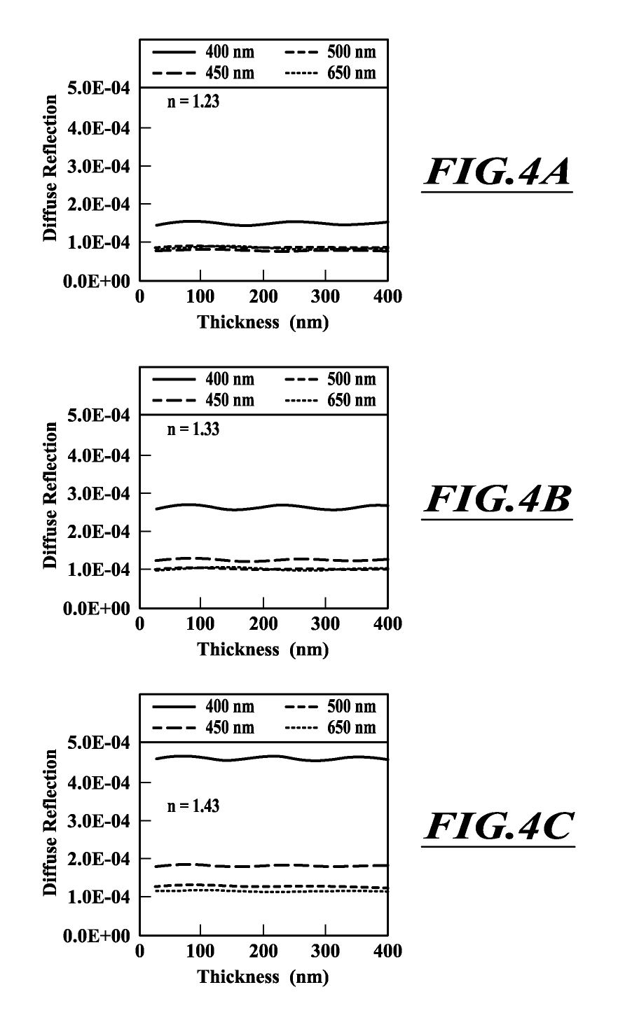

FIGS. 4A-4C show curves of diffuse reflection for several wavelengths in various media and at various thicknesses.

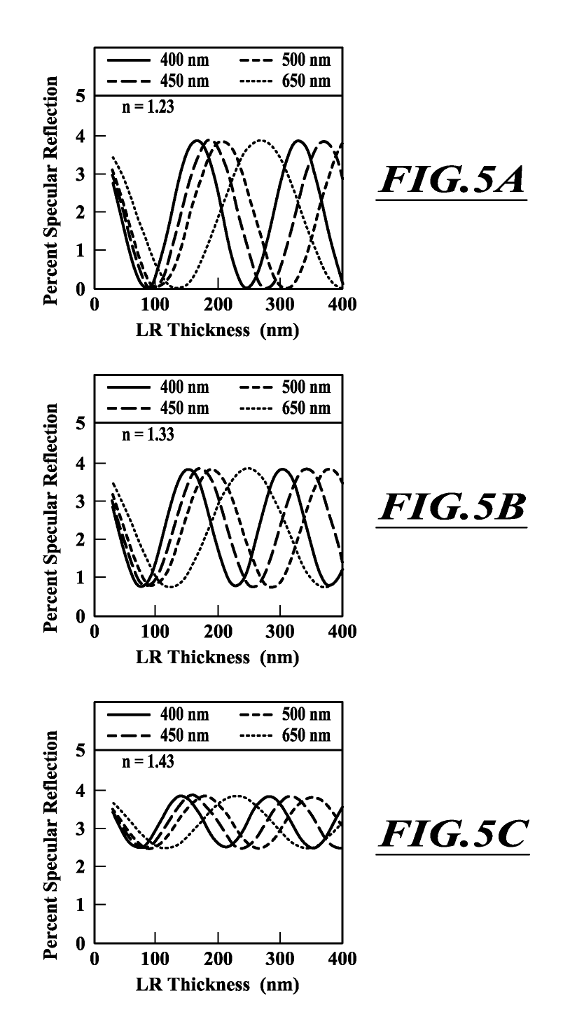

FIGS. 5A-5C illustrate specular reflection for several wavelengths in various media and at various thicknesses.

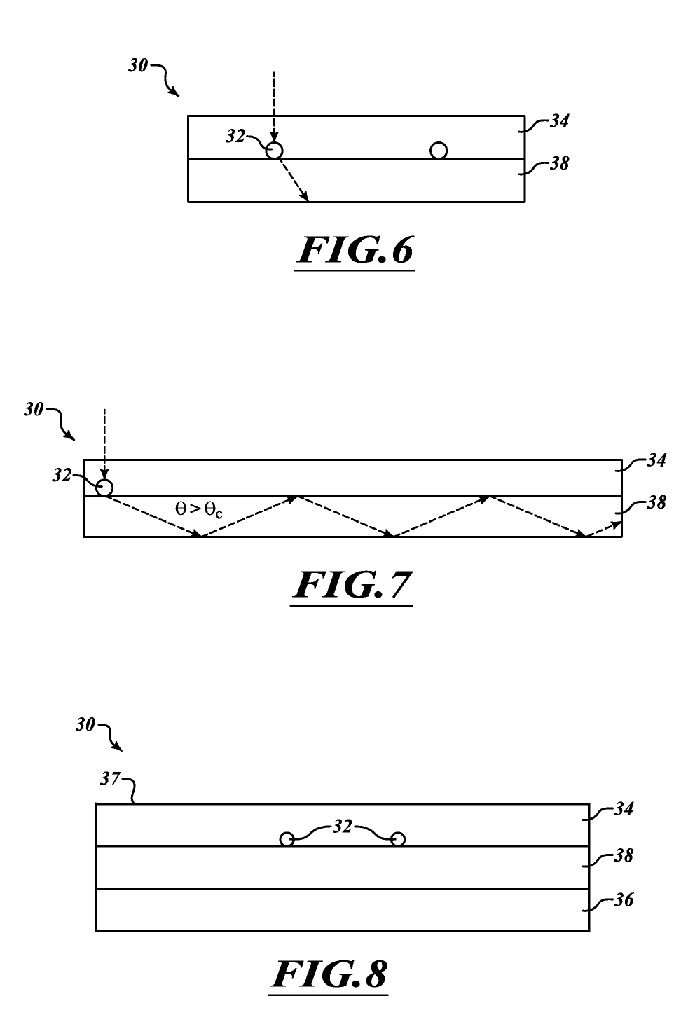

FIG. 6 is a cross section of an optical stack according to one embodiment.

FIG. 7 illustrates total internal reflection in an optical stack.

FIG. 8 is a cross section of an optical stack including three layers according to one embodiment.

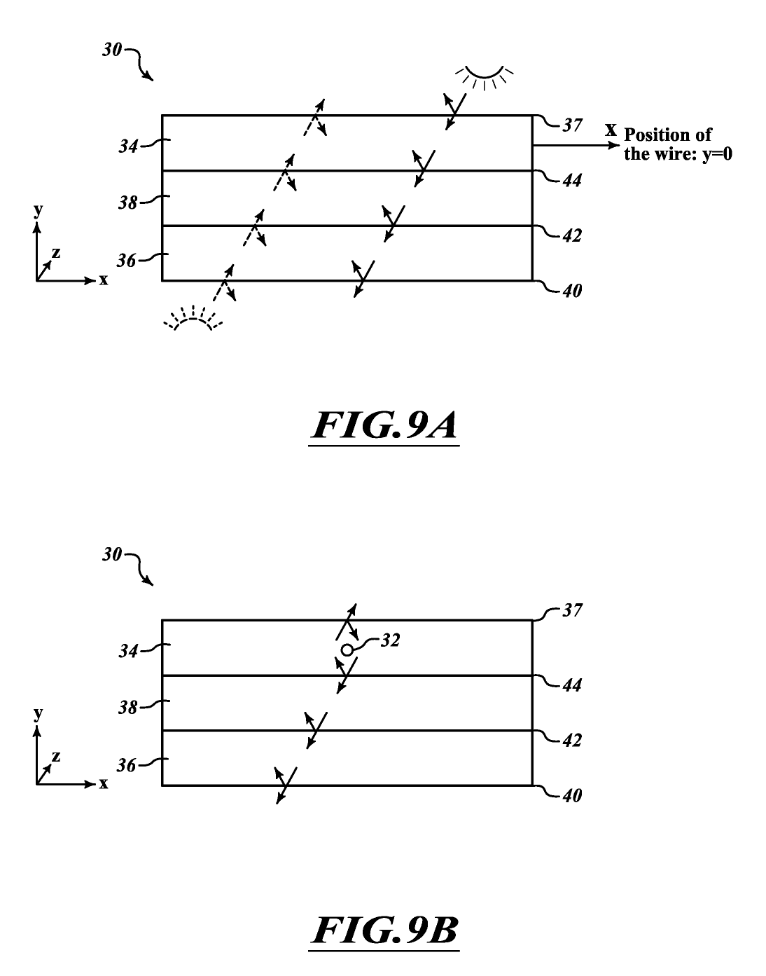

FIG. 9A is a cross-section of an optical stack illustrating top and bottom modes propagating in the optical stack according to one embodiment.

FIG. 9B is a cross-section of an optical stack illustrating top and bottom modes of diffusely scattered light propagating in the optical stack according to one embodiment.

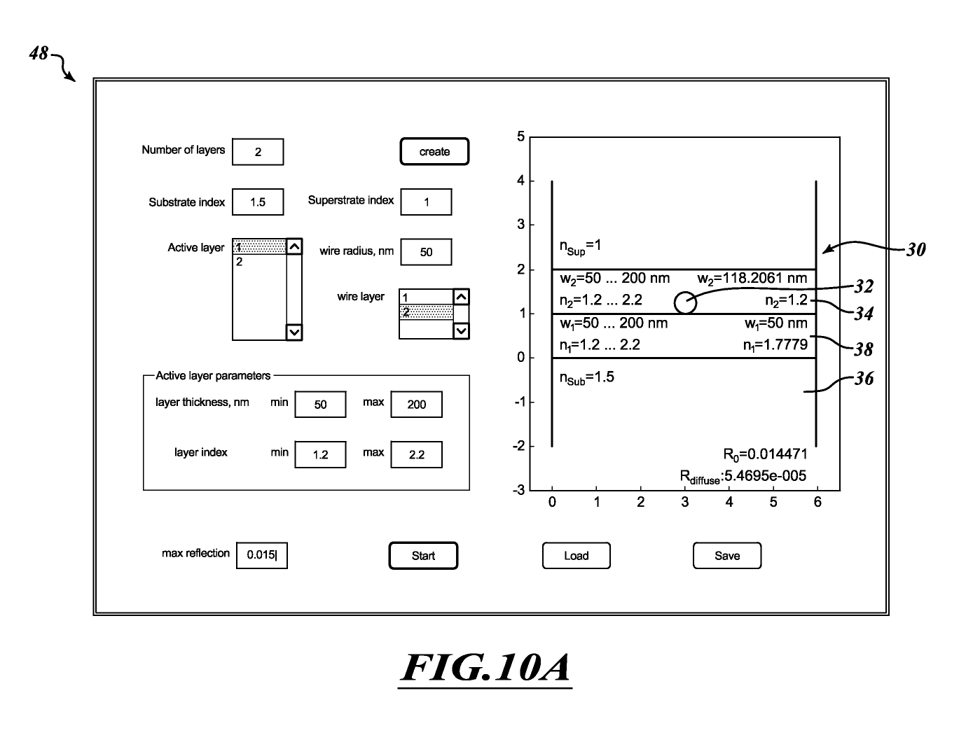

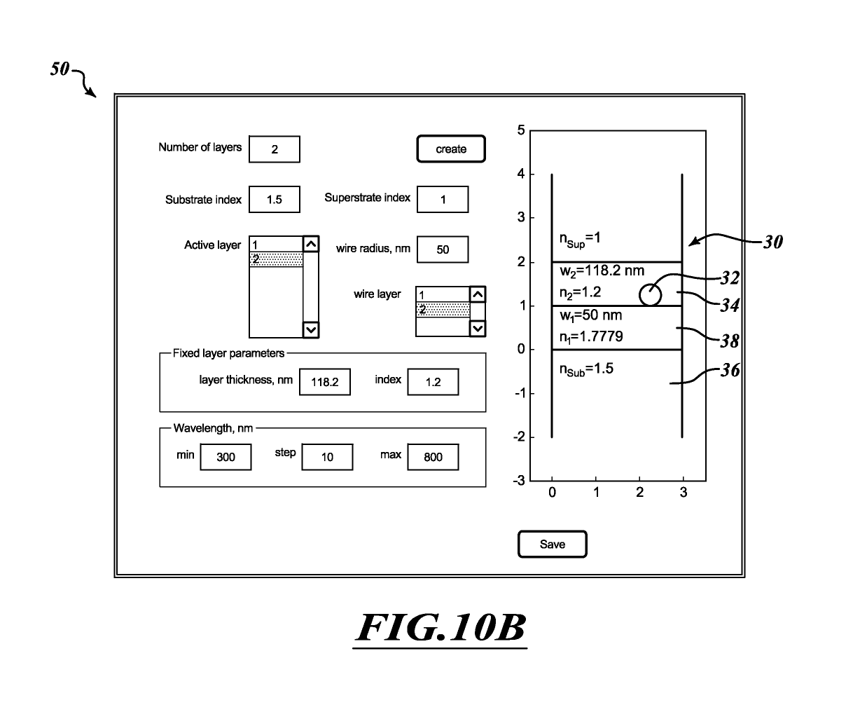

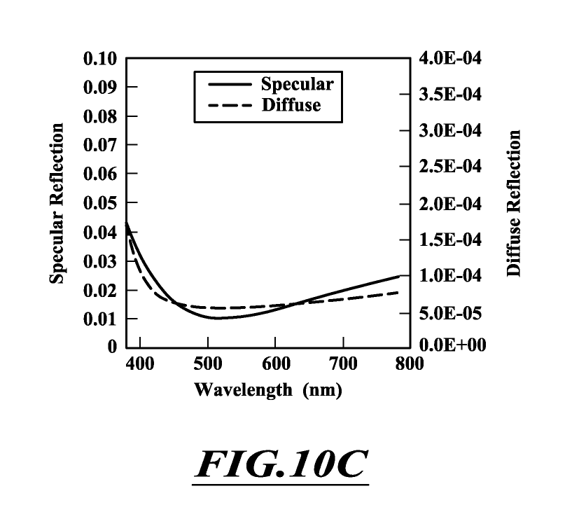

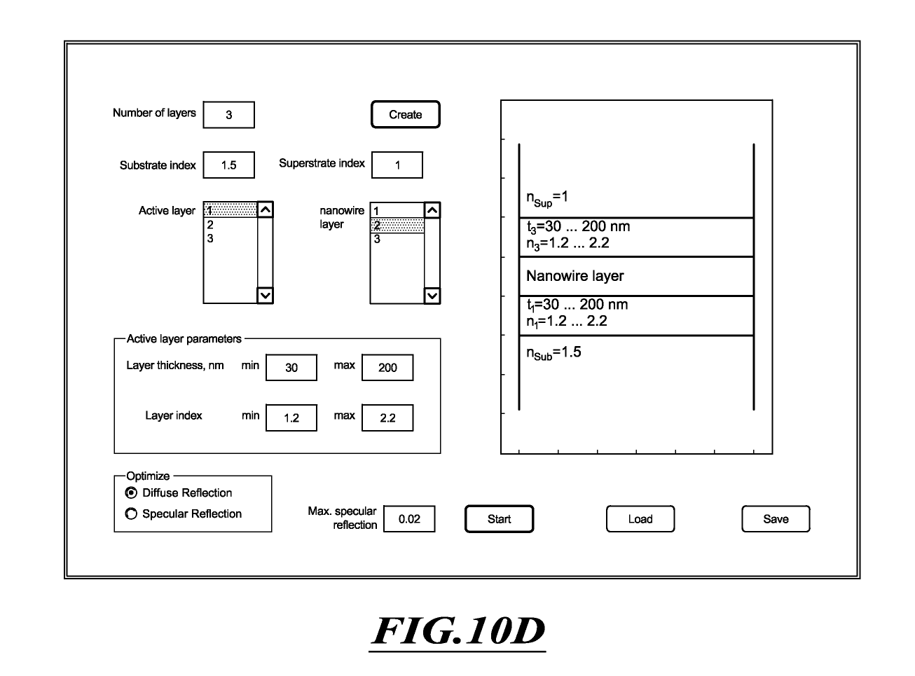

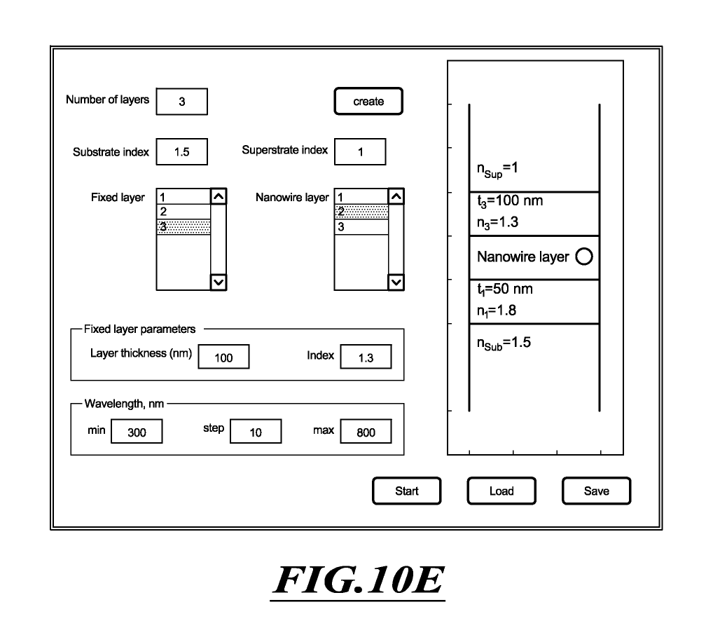

FIG. 10A illustrates a GUI according to one embodiment.

FIG. 10B illustrates a GUI according to a further embodiment.

FIG. 10C is a curve of optimized specular and diffuse reflection according to one embodiment.

FIG. 10D illustrates a GUI according to one embodiment.

FIG. 10E illustrates a GUI according to a further embodiment.

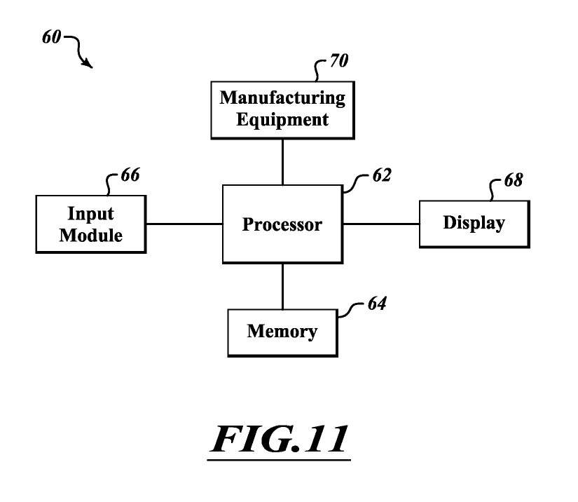

FIG. 11 is a block diagram of a system according to one embodiment.

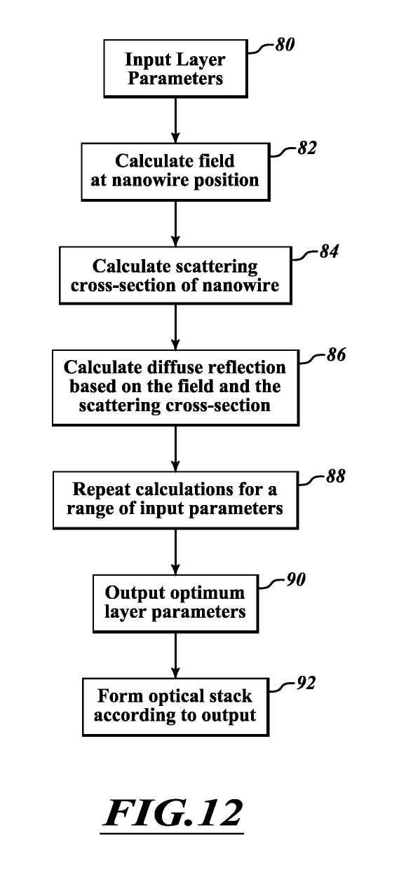

FIG. 12 is a method for reducing diffuse reflection from an optical stack according to one embodiment.

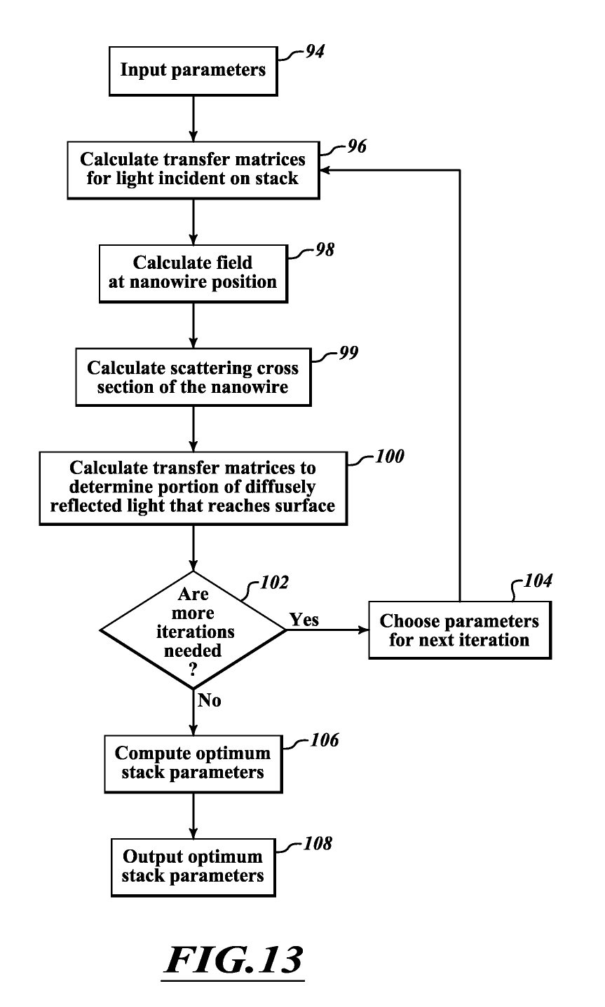

FIG. 13 is a method for reducing diffuse reflection from an optical stack according to a further embodiment.

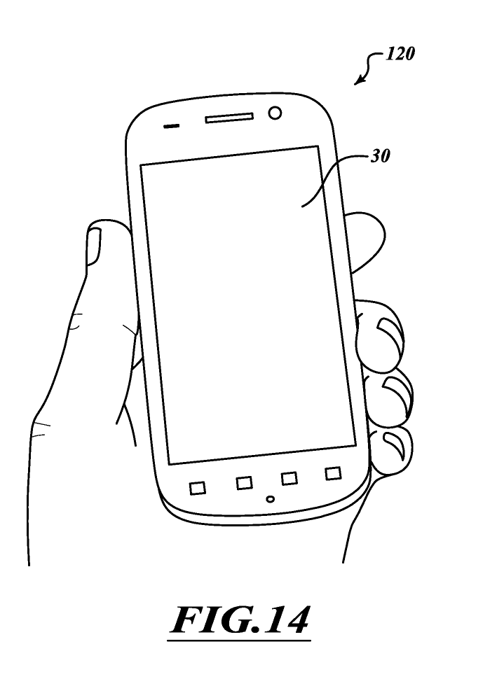

FIG. 14 illustrates a flat panel device including an optical stack according to one embodiment.

### DETAILED DESCRIPTION

Described herein include the underlying cause for the “milky” appearance of a nanowire display, methods for addressing the same, and optical stacks that have lower or no milky appearance. As used herein, “optical stack” refers to a multi-layer stack of thin films through which light from either an external or an internal source travels, one or more layers having an impact on the optical behavior of the light. The thin films within the optical stack are typically functional films such as transparent conductive films, polarizers, color filters, anti-glare films, or anti-reflective films, as well as protective coatings and clear adhesives. The thin films can be flexible (e.g., polymer substrate) or rigid (e.g., glass substrate). The optical stack is typically coupled to another functional unit such as a display. In addition to the films, air space between films or between the films and the display also contribute to the optical behavior of the light, and is considered a part of the optical stack.

Also in the context of film orientations, a film that “overlies” another film is configured to be more proximate to the external light source (or the viewer) than the other film. For instance, an overcoat that overlies the nanowire layer is always disposed between the external light source (or the viewer) and the nanowire layer. A film that “underlies” another film is configured to be less proximate to the external light (or the viewer) than the other film. For instance, in an optical stack that employs an undercoat that underlies the nanowire layer, the nanowire layer is always disposed between the external light source (or the viewer) and the undercoat.

FIG. 1 illustrates an optical stack 30 of a conductive transparent thin film. In the basic optical stack (30), as in more complex ones (e.g., in an entire touch panel), many or all of the layers or structural elements may contribute to the diffuse reflection to certain degrees. Various embodiments described here are approaches to lessen the diffusion reflection through manipulations and modification of individual layers or structural elements. However, it should be understood that any one or more individual embodiments may be combined to provide additive benefit in further reducing diffuse reflection. Thus, various embodiments are directed to optical stacks that comprises at least one nanowire layer; and at least one substrate adjacent to the nanowire layer, wherein the nanowire layer includes a plurality of conductive nanowires, and wherein a diffuse reflection of an incident light, as viewed from the same side of the optical stack as the incident light, is some percentage of the incident light. As used herein, “adjacent” refers to the relative locations of the substrate and the nanowire layer. They may be in immediate contact, or are near each other with one or more intermediate layers interposed between.

The optical stack 30 includes conductive nanowires 32 embedded in a transparent insulating layer 34. The transparent insulating layer 34 and the nanowires 32 are on a substrate 36.

The optical stack 30 is of a type which can be used in a flat panel display. As such, it is desirable for the optical stack 30 to have properties which most enhance the visual characteristics of the optical stack. As described previously, an optical stack 30 including nanowires 32 can suffer from a milky or hazy quality. This milky quality can detract from the visual characteristics of the optical stack 30. In particular, when it is desirable to display dark colors such as black, the optical stack 30 can instead display a milky color which adversely affects quality of the displayed images.

One source of these undesirable characteristics is diffuse reflection from the nanowires 32. Typically, when light encounters a surface or an object, the angle of reflection is identical to the angle of incidence. This is called specular reflection. Specular reflection is illustrated in FIG. 2A. In FIG. 2A, a ray of light is incident on the surface 37 of the optical stack 30 with an angle of incidence θᵢ. The ray is reflected from the surface 37 of the optical stack 30 at an angle θᵣ, which is equal to θᵢ.

However, as illustrated in FIG. 2B, some of the light which strikes the surface 37 of the optical stack 30, or indeed any surface, is also reflected diffusely. This diffuse reflection manifests itself in light being scattered in many directions other than the expected angle of reflection for a specular reflection. The light incident on the surface 37 is scattered in many directions in FIG. 2B. While a very small portion of light is typically reflected diffusely from any surface, the optical stack 30 of FIG. 2B suffers from further diffuse reflection due to the presence of the nanowires 32.

When light is incident on an object or a structure which has dimensions smaller than the wavelength of the light, the light is scattered diffusely from the object. The nanowires 32 and the optical stack 30 are, in general, smaller than 100 nm in radius, for example between 5 and 100 nm in radius. 100 nm is much smaller than the smallest wavelength of visible light. Thus, when any visible light encounters the nanowire 32, it is diffusely reflected from the nanowire 32. In a transparent film, the great majority of light which is incident on the surface 37, is transmitted through the surface 37 and into the layer 34 in which the nanowires 32 are embedded. It is only a small percentage of the light that is reflected at the surface. However, some fraction of the light which interacts with the nanowires 32 is reflected diffusely. This diffuse reflection is the major cause of the milky quality which can sometimes diminish the appearance an optical stack 30 including nanowires 32. It has been shown using calculations that the diffuse reflection from the nanowires 32 can be reduced in several ways when the nanowires 32 are incorporated in an optical stack 30.

One such method is to reduce the index of refraction of the layer 34 in which the nanowires 32 are embedded. FIG. 3A illustrates curves of diffuse reflection versus the wavelength of light which is incident on the nanowires 32. Three curves are shown, one each for layers having indices of refraction of 1.43, 1.33, and 1.23 respectively. The peak of the curve for the index of refraction of 1.43 is significantly higher than the curve for n equals 1.33 and n equals 1.23. For the layer whose index of refraction equals 1.43, the peak of diffuse reflection occurs when the wavelength of light is about 400 nm. 400 nm is on the edge of the visible spectrum, and corresponds to violet light. Humans typically are unable to see wavelengths smaller than 380 nm, which corresponds to ultraviolet light.

When the index of refraction is reduced to n=1.33, not only is the peak diffuse reflection reduced, but it is also shifted to a smaller wavelength. For the material whose index of refraction is n=1.33, the peak is reduced to about 6×10⁻⁴ and the peak wavelength is about 370 nm. Thus, not only is less light diffusely reflected back out of the surface 37 of the optical stack 30, but a larger portion of the light that is reflected is shifted out of the visible spectrum and into the ultraviolet spectrum. It should be noted here that diffuse reflection values are in arbitrary units in this graph but are nevertheless useful to understand the relative effect that changing parameters of an optical stack 30 has on the diffuse reflection.

The diffuse reflection for the material whose index of refraction is n=1.23 is smallest of the three curves. The peak diffuse reflection for n=1.23 is about 4.5×10⁻⁴. and, just as importantly, the peak wavelength is shifted even further into the ultraviolet range, which is not visible to the human eye. Thus, placing the nanowires 32 in a layer 34 whose index of refraction is smaller can both reduce the diffuse reflection and shift the peak diffuse reflection away from the visible spectrum.

It is also desirable to reduce the specular reflection as much as possible. FIG. 3B illustrates three curves of specular reflection versus the wavelength of light for the same three indices of refraction n as in FIG. 3A. As can be seen from FIG. 3B, specular reflection is highest for the layer 34 whose index of refraction is n=1.43. The peak specular reflection is about 0.04 for n=1.43. However, the peak is outside of the visible range at about 300 nm. For a layer 34 which has an index of refraction n=1.33, the peak specular reflection is decreased by a small amount. However, for most of the visible spectrum, which corresponds to about 400 nm to 700 nm in wavelength, the specular reflection for n=1.33 is far lower than the specular reflection for n=1.43. Thus, while the primary concern of the present disclosure is to reduce diffuse reflection, specular reflection is not to be neglected. Reducing both the specular reflection and the diffuse reflection can most enhance the visual characteristics of the optical stack 30.

For a layer 34 whose index of refraction is n=1.23, the specular reflection is lowest of all. Not only is the peak specular reflection reduced, but the specular reflection in a large portion of the visible spectrum is very close to 0, with a low point coming around 500 nm. Thus, it is highly beneficial for both the diffuse reflection and the specular reflection to reduce the index of refraction of the layer in which the nanowires 32 are embedded.

Another parameter of the optical stack 30 which can affect the specular and the diffuse reflection is the thickness of the layer 34 in which the nanowires 32 are embedded. FIG. 4A illustrates a curve of diffuse reflection versus the thickness of the layer 34 in which the nanowires 32 are embedded for several wavelengths and for an index of refraction of n=1.23. As can be seen, the diffuse reflection for light whose wavelength is 400 nm is slightly higher than for light whose wavelength is 450, 500, or 650 nm. Perhaps most notably, the diffuse reflection for any given wavelength remains mostly constant throughout the entire range of thickness from about 20 to 400 nm in thickness of the layer 34. Diffuse reflection for 400 nm light is both larger in magnitude and more variable than the diffuse reflection for the other wavelengths in FIG. 4A. In other optical stacks this is not the case. In fact, the thickness of the layer can be very important in some configurations.

FIG. 4B plots the diffuse reflection from nanowires 32 in a layer 34 whose index of refraction is n=1.33. The slight increase in the index of refraction results in an increase in the magnitude of the diffuse reflection. In particular, the diffuse reflection for light whose wavelength is 400 nm has increased more than the diffuse reflection for light whose wavelength is 450, 500, or 650 nm. Thus, FIGS. 3A and 3B and FIGS. 4A-4C illustrate that the diffuse reflection fluctuates most heavily near the violet end of the visible spectrum.

In FIG. 4C, the in index of refraction is n=1.43. With this increase in the index of refraction, a large increase in the diffuse reflection of 400 nm light has occurred. Smaller increases in the diffuse reflection for light whose wavelength is 450 nm, 500 nm, and 650 nm has also occurred, but to a much smaller extent.

However, specular reflection fluctuates greatly with a change in the thickness of the layer 34 in which the nanowires 32 are embedded. The specular reflection follows a sinusoidal wave pattern for each of the four wavelengths of light that are plotted in FIG. 5A. All of the wavelengths of light experience peaks and valleys in the magnitude of their specular reflection as the thickness of the layer 34 increases. As the thickness of the layer approaches 0, the specular reflection approaches a peak of about 4% for each of the four wavelengths of light.

As the thickness increases to about 100 nm, all four of the wavelengths plotted in FIG. 5A experience a minimum in the specular reflection. As the thickness of the layer 34 increases toward 200 nm, all four of the wavelengths of light again approach a peak. Light will experience constructive and destructive interference at positions throughout the optical stack according to the thicknesses of the layers in the stack. Additionally, light reflected from the surface 37 may be 180 degrees out of phase with the light reflected from below. Thus, depending on the thicknesses and materials of the layers 34, 38, light reflected from below can destructively interfere with light reflected from the surface 37 and thereby reduce the specular reflection.

In FIG. 5B, the specular reflection is plotted for the four wavelengths of light when the layer 34 has an index of refraction 1.33. The peaks and valleys occur at roughly the same places as they did when the index of refraction was 1.23. However, the minimums are now higher than for n=1.23. In particular, the minimums only dropped to about 1% specular reflection, whereas for n=1.23, the minimums drop to about 0.

In FIG. 5C, the index of refraction n=1.43 for the layer 34 in which the nanowires 32 are embedded. Here the peaks remain at about 4%, as in FIGS. 5B and 5A. However, the minimums in the percent specular reflection have increased to about 2.5% as opposed to 1% for n=1.33 and 0% for n=1.23. Thus, for reducing specular reflection, it is desirable to have a lower index of refraction in some optical stacks.

FIG. 6 illustrates an optical stack 30 according to one embodiment. The optical stack 30 includes nanowires 32 in an insulating layer 34, according to one embodiment. The layer 34 is placed on a layer 38 which is a high index of refraction layer.

The layer 38 is also optically transparent. The layer 38 can enhance forward scattering of diffuse light from the nanowire 32. When nanowire 32 is placed in a layer 34 having a relatively low index of refraction compared to the layer 38 more forward scattering of diffuse light is promoted. In other words, when light is diffusely reflected from a nanowire 32, more light will be scattered forward toward the layer 38. Thus, less light will diffusely reflect back toward the surface 37 of the optical stack 30. This is partially because there is an increased density of states for forward scattering relative to backward scattering when there is a higher index of refraction layer abutting the lower index refraction layer. The increased density of states promotes forward scattering as described previously.

A further advantage of having a high index of refraction layer 38 below the nanowire 32 is that total internal reflection of diffusely reflected light can occur within the high index layer 38 as illustrated in FIG. 7. The critical angle θ_{c} is the angle of incidence above which total internal reflection occurs. The angle of incidence is measured with respect to normal at the refractive boundary. When light is passing from a layer 38 of high index of refraction to a layer 34 of low index of refraction, the light which strikes the interface between the layers 34 and 38 is bent toward the high index of refraction layer 38. When the incident angle is large enough, the transmitted angle in the low index of refraction layer 34 reaches 90° relative to normal. At this point, the light is no longer transmitted into the low index of refraction layer 34. This interaction is governed by Snell's law which states:

nᵢsin(θ)₁=n₂sin(θ)₂.

By simple mathematics, the critical angle θ_{c} at which total internal reflection will occur can be calculated as follows:

θ_{c}=arcsin(n₂/n₂).

Therefore, the greater the difference of the low index of fraction layer 34 and the high index of refraction layer 38, the smaller the critical angle will be. As the critical angle becomes smaller, more light will undergo total internal reflection upon reaching the boundary of the high index of refraction layer 38 and the low index of refraction layer 34. Therefore, selecting a layer 38 having a sufficiently high index of refraction can further decrease the amount of diffusely reflected light that reaches the surface 37 of the optical stack 30. Thus, promoting total internal reflection is related to the enhanced forward scattering as described in relation to FIG. 6. In particular, the more light that is scattered forward from the nanowire 32 into the high index of refraction layer 38, the more light that will be totally internally reflected within the high index of refraction layer 38 and will not reach the surface and thus result in an increase in milkiness. In accordance with the principles discussed in relation to FIGS. 6 and 7,

FIG. 8 discloses an optical stack 30 according to one embodiment in which a high index of refraction layer 38 is placed below the low index of refraction layer 34 and above the substrate 36 as described previously. Having an optical stack 30 which includes a low index of refraction layer 34, nanowires 32 embedded in the low index of refraction layer 34 and adjacent a high index of refraction layer below the low index of refraction layer provides the enhancements described in relation to FIGS. 6 and 7. Having the substrate 36, which commonly will have an index of refraction that is between that of the low index of refraction layer 34 and the high index of refraction layer 38, provides additional structural support as well as enabling attachment to a flat panel device.

In spite of the benefits which are provided by the aforedescribed embodiments of an optical stack 30, optimization of the optical stack in order to minimize the diffuse reflection as well as the specular reflection, can still be very difficult. In order to provide an optical stack with minimal diffuse reflection, it is beneficial to utilize an efficient method for calculating or estimating the diffuse reflection of an optical stack 30 for a given configuration of layers and nanowires. The diffuse reflection for an optical stack 30 can be calculated by solving Maxwell's equations for the optical stack 30. The differential forms of Maxwell's equations which describe properties of electric fields E and magnetic fields B are as follows:

$$∇ \cdot E = \frac{ρ}{{ɛ}_{0}} , \\ ∇ \cdot B = 0 , \\ ∇ \cdot E = - \frac{\partial B}{\partial t} , \\ ∇ \times B = {μ}_{0} J + {μ}_{0} {ɛ}_{0} \frac{\partial E}{\partial t} ,$$

where ρ is the charge density due to free and polarization charges, J is the current density, ε₀ is the permittivity of free space, and, μ₀ is the permeability of free space. Utilizing

Maxwell's equations in a method of calculating the diffuse reflection is relatively difficult and can require large amounts of time and processing resources when diffuse reflection is to be calculated for many optical stacks 30. The complexity of Maxwell's equations make it very difficult to solve and compute preferred parameters of an optical stack 30.

Furthermore, each time new and different layers are added to an optical stack 30, Maxwell's equations are not easily manipulated to again provide a quick optimization of an optical stack 30 including additional parameters. In some cases, many layers both below and above the nanowires 32 may be added. Some optical stacks may be subject to particular constraints. Each time the parameters or constraints of the optical stack 30 are changed, Maxwell's equations would be solved anew, thereby using more time and processor resources.

A less resource intensive method for calculating the specular and diffuse reflections of an optical stack will be described in relation to FIGS. 9A and 9B via transfer matrices. Because Maxwell's equations are second-order partial differential equations, the complete set of solutions of these equations utilizes a set of at least two linearly independent families of solutions (modes). One embodiment defines these two families as “top” and “bottom” modes. The first class of solutions, top modes, corresponds to field distributions that could be initiated by the light incident on the system from the top, as in the case of specular reflection. The second class of solutions, bottom modes, describes the field distributions across the system that could be initiated by a light source on the substrate side of the structure (below layer 36 in FIG. 9a). These solutions also exist in the process of diffuse reflection.

Consider now the process of specular reflection in more detail in relation to the arrows on the right side of FIG. 9A. In this process, some amount of incident light is transmitted. FIG. 9A illustrates an optical stack 30 according to one embodiment. The nanowire 32 is not shown in FIG. 9A because calculations relating to the optical stack of FIG. 9A are performed as though the nanowire 32 is not present. The position y=0 in the optical stack corresponds to the position that the nanowire 32 would occupy in the optical stack. The optical stack 30 includes a low index of refraction layer 34 as described previously. The low index of refraction layer 34 is on a high index of refraction layer 38 and the high index of refraction layer 38 is on a substrate 36. A light source is irradiating the optical stack 30. Light is incident on the surface 37 of the low index of refraction layer 34.

The distribution of the EM field throughout the multilayered structure is calculated as if there were no nanowire. These calculations are performed with the transfer-matrices approach, where the field in each layer is represented as a series of plane waves moving up and down through the system (reflected/transmitted waves), and the amplitudes of these waves in the neighboring layers are related via transfer matrices.

The light from the light source is incident on the surface 37 of the optical stack 30. The arrows on the right side of the optical stack correspond to the top modes because they carry energy from the top of the system. Some amount of the incident light from the light source above the optical stack is transmitted through the surface 37 into the low index of refraction layer 34 as indicated by the arrow passing down into the layer 34 on the right side of the optical stack in FIG. 9A. Some percentage of the light incident on the optical stack 30 is reflected from the surface 37 as indicated by the arrow coming off at an angle from the arrow passing down into the layer 34. The angle of this arrow is not intended to be representative of the angle at which light is reflected from the surface, only to indicate that some of the light goes back up while some passes through. This is true with all of the arrows in FIG. 9A. Those arrows that seem to be at an angle are only at an angle to distinguish them from the arrows that pass through a boundary. In fact, the direction of light propagation depends on the source of illumination, and is described by the solutions of Maxwell equations.

Some of the light that passes through the boundary 37 from air continues in layer 34 until it reaches a boundary 44 between layers 34 and 38. At the boundary 44 some of the light passes through and some is reflected as indicated on the right side by the arrows passing through the boundary 44 downward and the arrow coming back into the layer 34 that represents the reflection at the boundary 44. This reflected light, in turn will come back to the boundary 37, partially contributing to the initial specular reflection (upward arrow) and partially to the initial transmission (downward arrow). In the context of the FIG. 9a, these subsequent re-reflections and re-transmissions are combined together and are represented by the single combination of transmitted (downward) and reflected (upward) arrows. Such a description is consistent with transfer the matrix technique, according to one embodiment, that can be used to automatically calculate the overall reflection/transmission coefficients.

Again at the boundary 42, some portion of the light that passes through layer 38 to the boundary 42 is passed through the boundary 42 into the layer 36. Likewise, a portion of the light that is incident on the boundary 42 is reflected back into the layer 38. Some amount of light is passed through the boundary 40 and into any layers that are below the layer 36.

A hypothetical light source is illustrated below layer 36 of the optical stack 30. The dashed arrows on the left side of the optical stack originate from this light source and correspond to the “bottom modes” because they carry energy from the bottom of the system upward. Some amount of the light, passing through the boundary 40 propagates into layer 36 of the optical stack toward the boundary 42 while some portion of this light will be reflected. At the boundary 42, some amount of the light is passed through the boundary 42 from layer 36 to layer 38. At the same time, some light is reflected at the boundary 42 back toward the boundary 40. Again, at the boundary 44, some light is passed through to the layer 34 while some is reflected at the boundary 44 back into the layer 38.

Finally, at the surface 37 of the optical stack 30 some light passes from layer 34 into the air surrounding the optical stack 30.

By utilizing transfer matrices, the amplitudes of the fields propagating up and down in each layer can be calculated. In particular, calculation of the amplitude of the light reflected up from the interface 37 for the top mode can be used to calculate the total specular reflection very accurately. Furthermore, the amplitudes of other waves composing the top modes can be used to calculate the electromagnetic field at any given vertical position within the stack 30. In this manner the field at the position of the nanowire 32 can be calculated.

In one embodiment, the dimensions of the optical stack in the z direction, ie., the direction into the page, are assumed to be infinite. Therefore, the total field in the optical stack 30 can be represented as a linear combination of two fields with different polarization. The first class of fields, known as TE waves, has its electric field component along the z axis so that its magnetic field has only x and y components. Similarly, the second class of waves, TM waves, have its magnetic field aligned with the z axis, and its electric field in the xy plane.

At an the interface between two arbitrarily chosen adjacent layers (j and +1) within the optical stack 30 it is assumed that the incident light is a plane wave with the wave vector having components {hₓ^{l}, k_{y}^{l}}. The relationship between the amplitudes of the plane waves in the neighboring layers can be determined by considering boundary conditions on electric and magnetic fields. Explicitly, for the interface between layers j and j+1 (corresponding to layers 34 and 38 for example) this relationship is given by

$$( \begin{matrix}{a}_{j + 1}^{-} \\ {a}_{j + 1}^{+}\end{matrix} ) = \frac{1}{2} ( \begin{matrix}1 + {K}_{j} & 1 - {K}_{j} \\ 1 - {K}_{j} & 1 + {K}_{j}\end{matrix} ) ( \begin{matrix}{a}_{j}^{-} \\ {a}_{j}^{+}\end{matrix} ) ,$$

where α⁻ and α⁺ are the amplitudes of the waves propagating in the negative and positive y direction respectively, the polarization-dependent constant Kⱼ is given by

$$\frac{\text{?}}{\text{?}}$$

$$\text{?} \text{indicates text missing or illegible when filed}$$

for TE-polarized waves and by

$$\frac{\text{?}}{\text{?}}$$

$$\text{?} \text{indicates text missing or illegible when filed}$$

for TM-polarized ones. The matrix connecting the amplitudes of the fields in the neighboring layers to each other is called a transfer matrix. Such a transfer matrix is only one type of transfer matrix which can be used in calculating specular reflection, diffuse reflection, or the amplitude of light waves for an optical stack 30. Many other types of transfer matrices may be used. Additionally, other methods which do not use transfer matrices can be used in calculating diffuse reflection according to principles of the present disclosure.

FIG. 9B illustrates the optical stack 30 of FIG. 9A in which the nanowire 32 has scattered light that was incident on the optical stack 30 on FIG. 9A. The light source that was present in FIG. 9A is not present in FIG. 9B to emphasize the focus now on diffuse reflection as opposed to specular reflection. Thus, the nanowire 32 has light scattering off it in a plurality of directions.

The diffuse reflection corresponds to the amount of light scattered from the nanowire 32 that exits the optical stack 30 through the surface 37. A method for calculating the diffuse reflection according to one embodiment therefore includes calculating the amount of light scattered from the nanowire 32 in all directions. As described previously, when calculating the transfer matrices to determine the specular reflection, the field at any position in the optical stack can also be calculated. One step in calculating the light scattered by the nanowire 32 is to calculate the field at the position of the nanowire 32.

Once the field at the position of the nanowire has been calculated or estimated, the amount of light scattered by the nanowire can be obtained by calculating or estimating the scattering cross-section of the nanowire 32. The scattering cross-section of the nanowire can be obtained by solving Maxwell's equations for a long cylindrical wire of the given shape. For a wire with a circular cross-section the scattering cross-section can be calculated without putting a great burden on the processing resources. The scattering cross-section can also be calculated for other shapes of wires such as wires with polygonal or other cross-sections. In one example of such calculations, the solutions of Maxwell equations is represented as a set of cylindrical waves, and the boundary conditions along the wire circumference are used to relate the amplitude of these waves. One realization of such a formalism is described, using an example of light emission from dielectric resonators, in the article (Viktor A. Podolskiy, Evgenii Narimanov, Wei Fang, and Hui Cao, Chaotic microlasers based on dynamical localization, Proc. Nat. Acad. Sci. v. 101 (29) pp. 10498-10500 (2004) and in references therein). This article is incorporated by reference herein in its entirety. Once such a relation is found, it is straightforward to relate the energy flux scattered by the wire to the energy flux incident on the wire, and use this relationship to calculate the scattering cross-section of the wire. The scattering cross-section describes what proportion of the light that is incident on the nanowire 32 will be scattered by the nanowire 32.

By multiplying the field from the light incident on the nanowire 32 by the scattering cross-section of the nanowire, the amount of light scattered by the nanowire 32 can be calculated. The total diffuse reflection from the optical stack 30 can be calculated or estimated by again calculating transfer matrices for the light scattered by the nanowire 32 within the optical stack 30. The diffuse reflection is the amount of light scattered by the nanowire 32 that exits the optical stack 30 from the surface 37. In one embodiment the nanowire is treated as though it scatters light in all directions equally. Mathematically, the spectrum of the diffusely scattered light A (kₓ) does not depend on the x component of the wavevector kₓ.

Similar to the specularly reflected light in FIG. 9A, the diffusely reflected light from the nanowire in FIG. 9B also both transmits through and reflects at each boundary within the optical stack. The transfer matrices for calculating the diffuse reflection are computed for top and bottom modes as described previously.

Light that is forward scattered from the nanowire 32 as described previously will be incident on the boundary 44 between the layers 34 and 38. A portion of this light will be reflected back toward the surface 37. A portion of the forward scattered light from the nanowire 32 will transmit through the boundary 44 into the layer 38. Light will again propagate to the boundary 44 between the layers 38 and 36 where some of it will be transmitted and some will be reflected back up toward the boundary 44. Some of the light that is transmitted through the boundary 36 will reflect at the boundary 40 and some will pass through the boundary 40. The total light that passes through the boundary 40 will represent diffusely transmitted light. The light reflected by each of the interfaces 44, 42, 40, will contribute to the diffuse reflection. However, the main contribution to diffuse reflection comes from the light emitted into the bottom modes of the system (shown above the nanowire in FIG. 9B). The amount of light transmitted through the interface 37 (that will represent the total of the light scattered by the wire into the bottom modes and the portion of the light originally emitted into the top modes that is subsequently reflected by the interfaces 44,42,40) represents the total diffuse reflection in the system.

The diffuse reflection can be calculated in a manner similar to the specular reflection as described in relation to FIG. 9A. Namely, the scattering cross section is acquired and transfer matrix calculations are performed for the diffusely scattered light for transmission and reflection at all boundaries within the stack 30. In this manner, the total diffuse reflection can be closely approximated while using relatively little processing resources.

In one embodiment, the field at the position of the nanowire can include both the field from the incident light and the field from previously scattered light. In other words, some of the light scattered by the nanowire 32 will reflect within the optical stack 30 and again be scattered by the nanowire 32. The accuracy of the calculation of diffuse reflection can be improved by taking into account the field from diffusely scattered light at the position of the nanowire.

Calculation of light scattering is generalized to take into account the phase of the scattered light. To achieve this, the radius of the nanowire is assumed to be extremely small, so that its scattering is dominated by the lowest-possible cylindrical harmonics (empirical calculations indicate that TE scattering is dominated by m▪2[polar-angle-independent] cylindrical mode, while TM scattering is dominated by m▪1[dipole-like] cylindrical mode. As such, the spectrum of the scattered waves is proportional to:

$${A}_{TE} ( {k}_{x} ) α \frac{1}{{k}_{y}}$$

$${A}_{TM} ( {k}_{x} ) ∝ \frac{\text{?}}{n ω} , \\ \text{?} \text{indicates text missing or illegible when filed}$$

where n is refractive index of the material surrounding the wire, k is the wave vector and w is the angular frequency. Note that when the radius of the nanowire is sufficiently small, both cases reduce to the previously described kₓ independent spectrum.

The scattered light is represented as a sum of the “emitted” waves (bottom modes for y>0, top modes for y<0) plus the sum of the reflected components of the top and bottom modes respectively. The amplitude of the top and bottom modes emitted by the source is the same for the TE polarization and is opposite for the “dipole” TM polarization. When the interference of the top and bottom modes is taken into account, the effective amplitude of the emitted light becomes:

$$\begin{matrix} {a}_{b}^{+} = a ( {k}_{x} ) \frac{\text{?}}{\text{?}} \text{?} \\ = a ( {k}_{x} ) \frac{\text{?}}{\text{?}}\end{matrix}$$

$$\text{?} \text{indicates text missing or illegible when filed}$$

for the TE waves and

$${a}_{b}^{+} - a ( {k}_{x} ) \frac{\text{?}}{\text{?}} \text{?} -- a ( {k}_{x} ) \frac{\text{?}}{\text{?}}$$

$$\text{?} \text{indicates text missing or illegible when filed}$$

for TM waves, with α(kₓ) being the amplitude of the emitted light and r₁, r₂ being the reflection coefficients of the components of top and bottom modes.

To calculate the feedback field, ie the diffusely scattered light again incident on the nanowire 32, we multiply the emitted fields by their respective reflection coefficients and add the two together. Therefore, the total amplitude of the field at the location of the wire becomes:

$${a}_{tot} = {a}_{0} {\sum }_{{k}_{x}} [ \text{?} \frac{\text{?}}{\text{?}} + \text{?} \frac{\text{?}}{\text{?}} ] a ( {k}_{x} ) d {k}_{x} , \\ \text{?} \text{indicates text missing or illegible when filed}$$

for TE waves, and

$${a}_{tot} = {a}_{0} {\sum }_{{k}_{x}} [ \text{?} \frac{\text{?}}{\text{?}} - \text{?} \frac{\text{?}}{\text{?}} ] a ( {k}_{x} ) d {k}_{x} , \\ \text{?} \text{indicates text missing or illegible when filed}$$

for TM waves.

The factor represents the step in wavevector spectrum utilized in numerical calculations. A self consistent calculation of the field at a position of the nanowire can include incident light from the external light source and diffusely reflected light. In a self consistent solution, the field can be described as

a(k_{w})=A(k_{N})a ₜₒₜ,

leading to the matrix relation describing the emission spectrum:

a(kₓ)▪[1−dkₓRA]⁻¹Aaₐ(kₓ¹).

Where A(kₓ, kₓ¹) describes the scattering from the plane wave with wavevector kₓ¹ into the plane wave with the wavevector kₓ, and the (diagonal) matrix R̅ has components corresponding to the coefficients for aₜₒₜ described previously.

As mentioned above, these calculations can be simplified in the case when the percentage of the diffusely reflected light coming back to the wire position of the nanowire is small. In this case, the energy flux of the spectral component of the diffusely reflected light is enhanced by

$${\vert \frac{1 + {r}_{t}}{1 - {r}_{b} {r}_{t}} \vert}^{2} .$$

Using the convenient methods for calculating or estimating the diffuse reflection of an optical stack as described above, an optimization program can be utilized to calculate the diffuse reflection of many optical stacks 30 having different parameters in order to find an optical stack 30 which gives the lowest diffuse reflection. Commercially available optimization programs, such as those available in Matlab, can be used to optimize diffuse reflection, according to principles of the present disclosure, for many optical stack configurations. Such optimization programs can assist in finding an optical stack having a relatively low diffuse reflection in conjunction with the methods for calculating diffuse reflections described above.

While the calculations of diffuse and specular reflection have been described above in terms of transfer matrices, other methods besides transfer matrices can be used to obtain a value of diffuse reflection according to principles of the present disclosure. Such other methods also fall within the scope of the present disclosure.

One example of such methods include the extension of the presented approach to optimize specular and diffuse reflection from the optical stack that is incorporated inside a fixed set of thick layers, which may include thick underlayer (for example, optical adhesive) or thick overlayer (for example, protective glass layer). Here “optically thick” means that the thickness of the layer is greater or comparable to the coherence length of the radiation present it the stack. .

Propagation of light through optically-thick layers is somewhat similar to the process that yields the formation of top and bottom modes described above. Consider, for example, specular reflection of the top mode shown in FIG. 9A. As described above, light that enters the optical stack through the interface 37 will partially reflect and partially transmit through this interface. The transmitted portion will enter the layer 34 and reach the interface 44, where part of the light will be transmitted into the layer 38, and part of the light will be reflected back into the layer 34. This reflected light will reach the interface 37, where it will be partially transmitted outside the optical stack (contributing to specular reflection), and partially reflected back into optical stack. When the layer 34 is optically thick, the second (and subsequent) contributions to specular reflection will not interfere with the light originally reflected by the interface 37. Rather, the corresponding energy fluxes will be added together. It is straightforward to calculate specular reflection of the stack incorporating several optically-thick layers based on (energy-flux-based) reflectivities (R), and transmittivities (T) of the inter-layer interfaces.

For example, the following recursive technique can be used. Assume that layers in FIG. 9A are optically-thick. Then reflectivity of the interface 40 can be calculated using absolute value square of the corresponding Fresnel coefficient. Then the reflectivity of light entering interface 42 can be calculated as

$${\tilde{R}}_{i} = {R}_{i}^{+} + \frac{{T}_{i}^{2} {\tilde{R}}_{i - 1}}{1 - {R}_{i}^{-} {\tilde{R}}_{i - 1}}$$

Here \tilde{R} is the (overall) reflectivity of light entering the system from 42 from layer 38, Rᵢ⁺ is the single-interface reflectivity of the interface 42 when light travels from the layer 38, Rᵢ⁻ is the reflectivity of the same interface for the light travelling into layer 38 (often Rᵢ⁻=Rᵢ⁺), and \tilde{R}ᵢ₋₁ is the overall reflectivity of light entering on the interface 40. The same equation can be then used to calculate overall reflectivity of light entering interface 44, and finally, interface 37.

If the system contains a mix of optically-thick and optically-thin layers, the transfer matrix formalism can be used to calculate the optical properties (reflectivity and transmittivity) of optically-thin layers, which can be then be approximated as single interfaces (with known reflectance/transmittance) in optically-thick stacks.

Similar techniques can be utilized to calculate diffuse reflection in the presence of optically-thick layers.

FIG. 10A represents a graphical user interface (GUI) 48 of an optical stack optimization software program stored in a computer readable medium. The GUI can be displayed on a display coupled to a processor to allow a technician to implement the optimization program for finding an optical stack 30 having parameters that will yield a preferred value of diffuse reflection. The processor reads software instructions from a memory circuit coupled to the processor. The software instructions for running an optimization program to find preferred parameters of the optical stack 30 are therefore stored in the memory coupled to the processor. The processor therefore causes the display to display the GUI and a technician can input via a mouse and keyboard or any other suitable input device the ranges of parameters for an optical stack. The parameters can include the number of layers in the stack, the indices of refraction of the substrate 36, as well as the environment in which the optical stack 30 will be placed.

Therefore, in the exemplary GUI 48 in FIG. 10A the superstrate index of refraction is 1 because it is air. The substrate index of refraction is listed as 1.5 and corresponds to the substrate 36 of the optical stack 30. The user can input any substrate or superstrate index as desired. The radius of the nanowire 32 is also entered in order to calculate the scattering cross section. The wire radius entered in the GUI 48 according to one embodiment is 50 nm. However, the wire radius can be any other suitable radius according to the particular nanowires 32 or other nanostructure that are used in the optical stack 30. The user can likewise select which layer of the optical stack 30 the nanowires 32 are located in. In the exemplary GUI 48 of FIG. 10A, the wire layer has been selected as layer two which corresponds to layer 34 of the optical stack 30. In the field labeled active layer parameters, the user can enter minimum and maximum thicknesses for the layers 34 and 36 corresponding to layers one and two of the GUI 48. In the example of FIG. 10A, both the layer 34 and the layer 36 have ranges from 50 nm to 200 nm in thickness. The index of refraction for each of the layers 34 and 36 ranges from 1.2 to 2.2. These ranges are limits within which the optimization program will select parameters for optical stacks 30 in order to calculate which parameters yield the best diffuse reflection. When the program is executed, the diffuse and specular reflections are calculated for several optical stacks having parameters within the input ranges of layer thicknesses, indices of refraction, and wavelengths of light. The optimization program calculates the diffuse and specular reflection according to the methods previously described or using other suitable methods according to principles of the present disclosure.

In one embodiment, rather than calculating the diffuse reflection for every possible iteration within the input ranges, the optimization program calculates diffuse reflection for a first group of optical stacks having a variety of parameters within the given ranges. The optimization program then selects a second set of optical stacks having parameters varying somewhat from those which yielded the lowest diffuse reflections in the first group. The optimization program continues to calculate the diffuse reflection of optical stacks in this manner until a preferred diffuse reflection has been found. The optimization program can efficiently find the parameters which yield a preferred diffuse reflection without computing every possible iteration. In this way, the particular configuration of the optical stack 30 which yields a relatively low diffuse reflection can be selected. This is possible because of the aforedescribed simpler method for calculating or estimating the diffuse reflection of an optical stack 30.

It is possible to have a low diffuse reflection while having an unacceptably high specular reflection. For this reason, below the active layers parameters field is a field labeled as max reflection. In this field a technician can specify the maximum tolerable specular reflection. In this case the maximum specular reflection has been selected as 1.5%. This means that when the transfer matrices are run for both the specular reflection and the diffuse reflection, the preferred stack configuration will be chosen for the lowest diffuse reflection yield in which the specular reflection not greater than 1.5%.

In the field to the right, is illustrated an optical stack. The optical stack 30 includes the layer 34 of a lower index of refraction, including the nanowire 32, on top of layer 38 of higher index of refraction. Layer 38 is on the substrate 36 which has an index of refraction of 1.5. The index of refraction for the air above the optical stack is 1. In the layers 34 and 38 on the left side of each layer, the ranges of thickness and the ranges of the indices of refraction are given. This is noted by w₂=50 nm to 200 nm on the left side of layer 34 and n₂=1.2 to 2.2. These are the ranges for the thickness and the index of refraction of layer 34 for which the iterations will be performed in calculating the transfer matrices to find the specular and diffuse reflection. The layer 38 on the left side likewise specifies the range w₁=50 nm to 200 nm and n₁=1.2 to 2.2. On the right side of the layer 34, the preferred thickness and the preferred index of refraction are listed. In particular, the preferred thickness of the layer 34 is given as 118.2 nm. The preferred index of refraction of the layer 34 is 1.2. The preferred thickness of the high index of refraction layer 38 is 50 nm and the preferred index of refraction is 1.7779. Below the optical stack, the specular reflection is listed as R₀=0.0144 or about 1.4%. The diffuse reflection R_{diffuse} is listed as 5.469×10⁻⁵.

Thus, the GUI 48 which enables operation of the method for optimizing an optical stack 30 allows a user to input first parameters for the optical stack or input parameters and the program is run, the calculations are made, and the preferred specular and diffuse reflections are listed as well as the layer thicknesses and indices of refraction which yield those preferred results. It will be understood by those of skill in the art in light of the present disclosure that many modifications can be made to the method which has been described as well as the particular GUI and the inputs and outputs provided thereby.

FIG. 10B illustrates a GUI 50 according to one embodiment. The GUI 50 relates to a method by which a detailed plot of the specular and diffuse reflections for a variety of wavelengths can be computed based on the preferred parameters output in the GUI 48 from FIG. 10A. In particular, a user can enter the number of layers from the preferred output which is two in this case, the substrate index for the substrate layer 36 which is 1.5, and the superstrate index of refraction which is 1. Thereafter, an active layer can be selected, in this case the active layer two is highlighted which means that the parameters of the layer 34 can be entered in the fixed parameters field. The preferred characteristics as determined by the GUI 48 from FIG. 10A were 118.2 nm for the thickness of the layer 34 with an index of refraction of 1.2. The active layer can then be highlighted and the preferred characteristics calculated in relation to GUI 48 from FIG. 10A for the layer 38 can be entered. In this case, the preferred characteristics are 50 nm in thickness and an index of refraction of 1.7779. The range of the wavelength of light for which the plot will be generated can be entered in the field below to fix layer parameters labeled as wavelength in nm. In this case, the minimum wavelength is 300 nm and the maximum wavelength is 800 nm to be iterated in steps of 10 nm.

FIG. 10C illustrates the plot generated by the GUI 50 from FIG. 10B. In particular, FIG. 10C is a plot of the specular and the diffuse reflection for a range of wavelengths as specified in FIG. 10B. Both the specular and the diffuse reflection experience a peak just short of 400 nm in the ultraviolet range. The specular reflection dips down and hits a minimum of about 1% at a wavelength of 500 nm and then increases gradually to about 2.5% at 800 nm. The diffuse reflection dips down and hits a low around 500 nm as well, but stays relatively flat all the way through 800 nm, just sloping up very gradually. The diffuse reflection, in this case, has been kept to about 5×10⁻⁵ through the majority of the visible spectrum. The specular reflection has been kept between 1% and 2% for the majority of the visible spectrum.

Within the software instructions stored in memory, certain wavelengths of light can be weighted more heavily than other wavelengths of light. When the transfer matrices are calculated, each transfer matrix is performed for a range of wave lengths in addition to the range of thicknesses of the layers and indices of refraction of the layers. When calculating the preferred diffuse reflection, the reflection at some wavelengths can be weighted more heavily than others in one embodiment. The human eye is more sensitive to certain wavelengths than to others. Thus for some optical stacks, the diffuse reflection may be somewhat higher at less prominent wavelengths, while more prominent wavelengths are near a minimum. In such a case the diffuse reflection may be a preferred diffuse reflection despite some wavelengths not being near a minimum of diffuse reflection. For this reason it may be desirable to give a stronger weight to the diffuse reflection of some wavelengths. In one example the visible spectrum is divided in increments of 50 nm between 400 and 700 nm. The software which stores the program for calculating diffuse reflection can be modified to give higher or lower relative weights to the various wavelengths. For example, in one embodiment wavelengths between 450 nm and 600 nm are weighted more heavily than other wavelengths. The weighting, of course, can be selected by a technician who alters the code stored in the memory. The weighting can also be implemented for calculations of the specular reflection.

FIG. 10D illustrates a GUI for software program configured to find an optical stack having a relatively low diffuse reflection according to one embodiment. The GUI of FIG. 10D allows a user to select a number of layers of the optical stack 30 and in which layer the nanowire 32 will be located. The number of layers in the example of FIG. 10D is three and the nanowire layer is layer 2. After the nanowire layer has been selected, the user can enter the ranges of thickness and index of refraction of the other layers in the optical stack 30. However, in the embodiment of FIG. 10D the thickness and index of refraction of the nanowire layer cannot be altered through use of the GUI; these parameters are fixed in the embodiment of FIG. 10D. The parameters of layer 1 can be entered by selecting layer 1 as the active layer, then entering the ranges of thickness and index of refraction in the labeled fields. The parameters of layer 3 can be entered in the same way. In FIG. 10D the user has selected a range of 30-300 nm for thicknesses of both layer 1 and layer 3. A range of 1.2-2.2 for indices of refraction for layers 1 and 3 has been selected. These ranges are the ranges from which the optimization program will select values of thickness and index of refraction for the layers during the optimization routine.

The index of refraction of the superstrate and substrate can also be selected by entering values in the labeled fields. These have been selected as 1 and 1.5 respectively in the example of FIG. 10D. Once these parameters have been selected a basic diagram of the layers of the optical stack 30 is displayed on the right side of the GUI indicating the position of the layers, the position of the nanowire layer, the ranges of index of refraction and thickness, and the indices of refraction for the superstrate and the substrate.

The user can also select whether the optimization routine will optimize diffuse or specular reflection by checking the appropriate selection in the optimize field. If diffuse reflection is selected for optimization, then a maximum specular reflection can also be selected by entering a value in the max specular reflection field. The program will select an optical stack having a low diffuse reflection and a specular reflection equal to or less than the selected maximum value. Alternatively, if the user selects the specular reflection for optimization, then the user can enter a maximum diffuse reflection value for the optical stack.

Finally the user can click on the start button to run the optimization program. The optimization program will then calculate the diffuse reflection and specular reflection for a number of possible optical stacks and select an optical stack having a relatively low diffuse reflection and a specular reflection less than the selected maximum value. The parameters of the selected optical stack will then be output. The user can also save the optimum optical stack parameters or load a previously saved optical stack by clicking on the appropriate buttons.

FIG. 10E illustrates a GUI for calculating and plotting both the diffuse and specular reflection from a according to an alternative embodiment. The GUI of FIG. 10E allows a user to select a number of layers of the optical stack 30 and in which layer the nanowire 32 will be located. The number of layers in the example of FIG. 10E is three and the nanowire layer is layer 2. The thickness and index of refraction cannot be altered through use of the GUI; these parameters are fixed in the embodiment of FIG. 10E. After the nanowire layer has been selected, the user can enter the thickness and index of refraction of the other layers in the optical stack 30. The parameters of layer 3 are entered by selecting layer 3 as the fixed layer, then entering the thickness and index of refraction in the labeled fields below. The parameters of layer 1 can be entered in the same way. The index of refraction of the superstrate and substrate can also be selected; these have been selected as 1 and 1.5 respectively. Once these parameters have been selected a basic diagram of the layers of the optical stack 30 is shown on the right side of the GUI. The nanowire layer is layer 2 in the example of FIG. 10E.

The range of wavelengths and the step size for the calculations and plots can also be entered. In the example of FIG. 10E, the range of wavelengths selected is between 300 and 800 nm in stems of 10 nm. After all fields have been populated the user can click the start button to begin the calculation routine. The specular and diffuse reflections are calculated for all wavelengths. A graph can be output showing the specular and diffuse reflection for each wavelength. A table can also be output showing the numerical values of the diffuse and specular reflection for each wavelength step in the range of wavelengths. Many other configurations of a GUI are possible as will be apparent in light of the present disclosure. All such other configurations fall within the scope of the present disclosure.

FIG. 11 illustrates a system 60 according to one embodiment. The system 60 includes a processor 62 configured to execute software instructions stored in the memory circuit 64. The memory circuit 64 stores data which is read by the processor to execute the optimization methods described previously. An input module 66 is also coupled to the processor 62. A technician operating the system 60 can input, at the input module 66, the input parameters of the optical stack 30, which parameters the processor 62 will then optimize and output parameters reflecting the optimization. A display 68 is coupled to the processor 62. The processor 62 can cause the GUI 48 or 50 to be displayed on the display 60. The technician then operating the input module 66 can input the appropriate field by visually viewing the GUI 48 or 50 on the display 68. The optimization parameters can be displayed on the display 68 as well.

In one embodiment, the system 60 includes manufacturing equipment 70 coupled to the processor 62. In such an embodiment, the processor 62 outputs the output parameters directly to the manufacturing equipment which then deposits the appropriate layers and thicknesses as described in the optimization output. For example, for an optical stack 30 including a low index of refraction layer 34 in which is embedded nanowires 32 and a high index of refraction layer 38 below the low index of refraction layer 34, as well as a substrate 36 below the high index of refraction layer 38, the optimization outputs can be given to the manufacturing equipment 70 which can then deposit the layer 38 on the substrate 36 and the layer 34 on the layer 38. The foregoing system 60 is given by way of example. Many other components and software instructions can be included but which have not been described herein. When a user operates the input module 66 to input the input parameters, the input parameters are stored in the memory 64 coupled to the processor 62.

In one embodiment, the memory 64 can include an EEPROM, ROM, SRAM, DRAM, or any other suitable memory. The software instructions for performing the optimization process can be stored in the memory 64. The input instructions can be temporarily stored in the memory 64 or in a separate cache memory coupled to the processor. Any suitable components for storing the input parameters and the software instructions such that they can be read by the processor 62 can be used. Alternatively, the output from a process for selecting parameters for an optical can be used to manufacture the optical stack without manufacturing equipment physically coupled to circuitry used in selecting the optical stack parameters.

FIG. 12 is a flow diagram illustrating a method for optimizing parameters of an optical stack 30. At 80, the technician inputs layer parameters to a processor. The input parameters are then stored in a memory coupled to the processor. The input parameters can include numbers of layers in an optical stack 30, ranges of thicknesses of the layers in the optical stack 30, ranges of indices of refraction of the layers in the optical stack 30, a range of wavelengths for which diffuse and specular reflection are to be calculated, and relative weight values to be given to the various wavelengths in the range of wavelengths. At 82, the processor calculates the field at the position of the nanowire 32 in the optical stack 30. The calculation of field at the position of the nanowire can be performed by using transfer matrices or any other suitable calculation that can provide the field at the position of the nanowire 32. In an alternative embodiment, as described previously, the calculation of field at the position of the nanowire can include the field from previously scattered light.

At 84, the scattering cross section of the nanowire 32 is calculated. The scattering cross section of the nanowire 32 gives an indication of the directions and magnitudes of scattering of diffusely reflected light from the nanowire 32. The nanowire 32 can diffusely reflect the light in any direction. At 86, the processor calculates the diffuse reflection based on the calculated field at the nanowire position and the scattering cross-section. In one embodiment, the diffuse reflection is estimated by calculating transfer matrices for the transmission and reflections of diffusely reflected light at each of the layer boundaries and through each of the layers in the optical stack 30.

At 88, the calculations of field at the position of the nanowire 32, the scattering cross section of the nanowire 32 and the diffusely reflected light that reaches the surface are repeatedly performed for a large number of optical stacks 30 across the range of input parameters. In one embodiment the diffuse reflection calculations are performed for a first group of optical stacks. The optical stacks of the first group can have values for layer thicknesses, indices of refraction of the layers, etc. selected to give a broad first sampling of optical stacks across the possible input ranges. For example, the first group of optical stacks can include optical stacks whose first layers respectively have a minimal thickness, a maximal thickness, and a few thicknesses spread out between. The diffuse reflections are calculated for the first group and compared to each other.

Diffuse reflection is then calculated for a second group of optical stacks. In one embodiment the parameters of the optical stacks of the second group are chosen, based in part on the diffuse reflections of the first group. For example, the second group of optical stacks includes optical stacks having one or more parameters close to one or more of the parameters of the optical stacks of the first group which yielded the lowest values of diffuse reflection. This allows the processor to find an preferred value of diffuse reflection without computing every possible optical stack within the ranges. But rather, the processor can analyze optical stacks whose parameters are most likely to have a low diffuse reflection. This process can be continued as long as desired to obtain as thorough an optimization process as time and computing power allow. In the end the processor can select the optical stack whose parameters yielded the best value of diffuse reflection. At 92, the optical stack 30 is formed by depositing layers having the characteristics corresponding to the optimum output parameters.

Materials that may be used in the layers of an optical stack fabricated in accordance with the present invention are known in the art. Examples of such materials include, for example, TiO₂ (R_{D}=1.8), polyimides (R_{D}=1.7), as well as clear polymers embedded with high refractive index particles such as ZnO, ZrO₂, and TiO₂.

Table 1 shows a number of relatively low refractive index optical materials that may be used in the layers of an optical stack fabricated in accordance with the present invention.

TABLE 1

| Overcoat | | | |
|---|---|---|---|
| Materials/ | Refractive | | Chemical |
| Vendors | index | Curing Methods | Identity/components |
| CYTOP | 1.33 | Thermal | Amorphous |
| (Asahi Glass) | | (180° C.) | Fluoropolymer |
| TU2205 (JSR) | 1.35 | UV (300 mJ/cm²) | Fluororesin + acrylate |
| | | | monomer + silica |
| | | | nanoparticles |
| LAL-2020 (TOK) | 1.21 | Thermal | Acrylic resin + silica |
| | | (100-200° C.) | nanoparticles |
| LAL-N6034 | 1.34 | UV | |
| (TOK) | | (200 mJ/cm²) | |

Table 2 shows a number of relatively high refractive index optical materials that may be used in the layers of an optical stack fabricated in accordance with the present invention.

TABLE 2

| | Refractive | | Chemical |
|---|---|---|---|
| Materials/Vendor | Index | Curing methods | Identity/components |
| Titanium( IV) | 1.8-2.2 | Thermal | TiO₂ precursor |
| isopropoxide | | (140-200° C.) | (R_{D} depends on the |
| | | | curing temperature) |
| PI2545 | 1.7-1.8 | Thermal (230° C.) | Polyimide |
| (HD Microsystems) | | | |
| OptiNDEX ™ D1 | 1.85 | Thermal (250° C.) | Polyimide |
| (Brewer science) | | | |
| OptiNDEX ™ A54 | 2.15 | Thermal (300° C.) | Organic-inorganic |
| (Brewer Science) | | | hybrid coating |
| Seramic SI-A (SiO₂ | 2.1-2.1 | Thermal/UV | Silicon dioxide |
| film) | | (350° C./<240 nm) | precursor |
| (Gelest) | | | |
| HAL-2080 (TOK) | 1.80 | Thermal (200° C.) | Acrylic resin + silica |
| HAL-N4076 (TOK) | 1.76 | UV + thermal | nanoparticles + titanium |
| | | (300 mJ/cm² + 200° C.) | dioxide (TiO₂) |
| | | | nanoparticles |
| KZ6661 (JSR) | 1.65 | UV (1 J/cm²) | acrylate monomer + |
| | | | ZrO₂ (RI ~2.13) |
| | | | particles |
| UR101 (Nissan | 1.76 | UV (800 mJ/cm²) | Triazine polymer |
| chemical) | | | mixtures |

Methods of depositing optical layers having desired thicknesses using coating, printing, sputtering or other techniques are understood in the art. Regarding coating techniques in particular, Edward Cohen and Edgar Gutoff, “Modern coating and Drying Technology” (John Wiley & Sons, 1992, see pp. 11 and 25-28), which is incorporated herein by reference, discusses coating layers having desired wet film thicknesses. The dry film thickness resulting from a given wet film thickness depends on the composition of the coating solution used and is understood by those of ordinary skill. Methods of coating and printing nanowire conductive layers are disclosed, for example, in U.S. Pat. No. 8,094,247 and U.S. patent applications Ser. Nos. 12/380,293 and 12/380,294, each of which is incorporated by reference herein.

FIG. 13 illustrates a method for optimization of the parameters of an optical stack 30 according to one embodiment. At 94, optical stack input parameters are input to a processor which stores the input parameters in a memory circuit. The processor executes software instructions stored in the memory to begin a method for optimizing the parameters of the optical stack. At 96, the processor calculates transfer matrices for light incident on an optical stack having values in the range of parameters that were input to the processor at step 94. By calculating the transfer matrices, the specular reflection from the surface 37 of an optical stack 30 can be obtained. Also calculating the transfer matrices, the field at the position of the nanowire 32 within the stack 30 can be calculated at 98.

At 99, the scattering cross section of the nanowire 32 is calculated. The scattering cross section of the nanowire 32 is an indication of the magnitude of diffusely reflected light scattered in each direction within the optical stack 30. At 100, transfer matrices are calculated for diffusely reflected light scattered in all directions from the nanowire 32 within the optical stack 30. The transfer matrices give the portion of the diffusely reflected light that reaches the surface 37 of the optical stack 30.

At 102, the processor checks to see if more iterations of the input parameters are needed. In one embodiment the processor will perform the diffuse reflection calculations for a first group of optical stacks. For example, if the range of possible thicknesses of the first layer is between 50 nm and 200 nm, the processor can compute values of diffuse reflection for the minimum and maximum thicknesses, as well as for a few thicknesses in between while holding other parameters constant. The values of diffuse reflection are compared and the processor selects the next iteration of values based on the comparisons of the diffuse reflections of the first group of optical stacks. The processor chooses the parameters for the next iteration at 104 and the processor performs the calculations for specular reflection, field at the nanowire position, and diffuse reflection for the new set of parameters. At 106, the processor selects a preferred diffuse reflection from the set of diffuse reflections that have been calculated for the range of input parameters and outputs the particular preferred parameters of the optical stack 30 that produce the preferred diffuse reflection.

FIG. 14 illustrates a flat panel device 120 including in a touch screen display an optical stack 30 according to one embodiment. The optical stack 30 has been produced having layer parameters obtained from the optimization process as described previously. The display of the flat panel device 120 does not suffer from the problems of milkiness or haziness as described previously.

While particular layers, thicknesses, and properties of an optical stack 30 have been described herein, many other suitable configurations of optical stacks are possible, including more or fewer layers, multiple layers of nanostructures, or any other suitable characteristics. All such stacks fall within the scope of the present disclosure.

Likewise, while the present disclosure has disclosed particular methods for optimizing optical characteristics of an optical stack 30, many other suitable variations in the method are possible. For example, the field, specular reflection, and diffuse reflection can be approximated in other ways while still falling within the scope of the present disclosure. More, fewer, or different parameters can be input to a processor to optimize the stack. Likewise, optimization can be performed in regards to other parameters aside from the specular and diffuse reflection. The word optimum should not be understood to mean the best possible configuration, but rather one value or configuration preferred above other values or configurations. Likewise, an optimum reflectance does not necessarily mean the lowest reflectance, but rather a desired reflectance among the possible reflectances.

The various embodiments described above can be combined to provide further embodiments. All of the U.S. patents, U.S. patent application publications, U.S. patent application, foreign patents, foreign patent application and non-patent publications referred to in this specification and/or listed in the Application Data Sheet are incorporated herein by reference, in their entirety. Aspects of the embodiments can be modified, if necessary to employ concepts of the various patents, application and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
selecting optical stack parameters for an optical stack with a nanowire;
calculating a plurality of diffuse reflection values each for a respective one of a plurality of optical stack configurations according to the optical stack parameters:
selecting one of the optical stack configurations based at least in part on a comparison of the diffuse reflection values; and
forming layers of the optical stack according to the selected optical stack configuration.

2. The method of claim 1 comprising calculating a plurality of specular reflection values each for a respective one of the optical stack configurations.

3. The method of claim 1 wherein calculating the diffuse reflection values comprises calculating a scattering cross-section of the nanowire.

4. The method of claim 1 wherein calculating the diffuse reflection values includes, for each optical stack configuration, respectively:
calculating an electromagnetic field from of incident light at a position of the nanowire within the optical stack; and
calculating transfer matrices for light scattered from the nanowire within the optical stack.

5. The method of claim 4 wherein calculating the diffuse reflection comprises calculating an amount of light scattered from the nanowire based on the scattering cross-section and the field from incident light at the position of the nanowire.

6. The method of claim 5 wherein calculating the field from incident light includes calculating an electromagnetic field from diffusely scattered light at the position of the nanowire.

7. The method of claim 1 wherein the plurality of optical stack parameters includes a number of layers for the optical stack.

8. The method of claim 1 wherein the plurality of optical stack parameters includes a range of thicknesses of the layers of the optical stack.

9. The method of claim 1 wherein the plurality of optical stack parameters include a range of indices of refraction of the layers of the optical stack.

10. The method of claim 1 wherein forming the layers of the optical stack includes:
forming a first layer on a substrate; and
forming a second layer on the first layer, the nanowire being positioned in the first or second layer.

11. The method of claim 1 further comprising calculating a plurality of specular reflection values each for a respective one of the plurality optical stack configurations according to the optical stack parameters.

12. The method of claim 11 wherein calculating the plurality of specular reflection values includes calculating transfer matrices for light incident on each of the optical stack configurations.

13. The method of claim 11 wherein selecting one of the optical stack configurations is based in part on a comparison of the specular reflection values.

14. The method of claim 1 wherein selecting one of the optical stack configurations includes selecting the optical stack configuration corresponding to a minimum value of diffuse reflection.

15. A method comprising:
inputting to a processor input optical stack parameters for an optical stack with a nanowire;
storing the input optical stack parameters in a memory circuit coupled to the processor;
computing, in the processor, a plurality of values of diffuse reflection for a plurality of optical stacks each having a respective configuration in accordance with the optical stack parameters, calculating the values of diffuse reflection including, for each configuration, respectively:
computing a value of electromagnetic field from incident light at a position within an optical stack corresponding to a position of a nanowire in the optical stack; and
computing transfer matrices to provide a value of diffuse reflection at a surface of the optical stack based in part on the value of electromagnetic field.

16. The method of claim 15 comprising:
comparing the values of diffuse reflection with each other; and
selecting one of the values of diffuse reflection.

17. The method of claim 16 comprising outputting from the processor a selected optical stack configuration corresponding to the selected value of diffuse reflection.

18. The method of claim 17 wherein the input optical stack parameters include a range of indices of refraction of at least one layer of the optical stack.

19. The method of claim 18 wherein the selected optical stack configuration includes an index of refraction from the range of indices of refraction.

20. The method of claim 17 wherein the input optical stack parameters include a range of thicknesses of a layer of the optical stack.

21. The method of claim 20 wherein the selected optical stack configuration includes a thickness from the range of thicknesses of the layer of the optical stack.

22. The method of claim 17 comprising forming the optical stack according to the selected optical stack configuration.

23. The method of claim 15 wherein computing the values of diffuse reflection comprises calculating a scattering cross section of the nanowire.

24. A system comprising:
a processor;
a memory coupled to the processor;
an input coupled to the processor and configured to receive first parameters of an optical stack, the processor being configured to compute a set of incident light electromagnetic field values for a position corresponding to a nanowire in an optical stack, compute a light scattering profile of the nanowire, compute a set of values of diffuse reflection at a surface of the optical stack, and estimate a set of second parameters of the optical stack, the second parameters corresponding to preferred values of the set of values of diffuse reflection; and
an output coupled to the processor and configured to receive the second parameters from the processor.

25. The system of claim 24 comprising a display coupled to the output, the display being configured to display the second parameters.

26. The system of claim 24 comprising a deposition device coupled to the output, the deposition device being configured to receive the second parameters and to deposit a first optical layer of the optical stack according to the second parameters.

27. A method comprising:
inputting parameters of an optical stack to a processor;
estimating, in the processor, a set of values of electromagnetic field from incident light for a position corresponding to a nanowire in an optical stack;
estimating, in the processor, a light scattering profile of the nanowire;
estimating, in the processor, a set of values of diffuse reflection at a surface of the optical stack based on electromagnetic field values and the scattering cross-section; and
outputting from the processor an optical stack configuration corresponding to a selected value of diffuse reflection.

28. The method of claim 27 wherein estimating the set of values of electromagnetic field includes computing first transfer matrices according to the parameters of the optical stack.

29. The method of claim 28 wherein estimating the set of values of the diffuse reflection includes computing second transfer matrices according to the parameters of the optical stack.
